(19) United States
(12) Patent Application Publication
(10) Pub. No.: US 2021/0301376 A1
(43) Pub. Date: Sep. 30, 2021

(54) HIGH-TENSILE STEEL CONTAINING MANGANESE, USE OF SAID STEEL FOR FLEXIBLY-ROLLED SHEET-PRODUCTS, AND PRODUCTION METHOD AND ASSOCIATED STEEL SHEET-PRODUCT

(71) Applicant: Salzgitter Flachstahl GmbH, 38239 Salzgitter (DE)

(72) Inventors: Peter Palzer, Liebenburg (DE); Thomas Evertz, Peine (DE)

(73) Assignee: Salzgitter Flachstahl GmbH, 38239 Salzgitter (DE)

(21) Appl. No.: 17/345,893

(22) Filed: Jun. 11, 2021

Related U.S. Application Data
(62) Division of application No. 15/749,732, filed on Feb. 1, 2018.

(30) Foreign Application Priority Data
Aug. 5, 2015 (DE) 10 2015 112 889.6

(51) Int. Cl. C22C 38/04; C21D 8/04; C22C 38/00; C22C 38/02; C22C 38/06; C22C 38/22; C23C 2/02; C21D 8/02; C22C 38/40; C21D 9/46; C22C 38/42; C21D 6/00; C22C 38/44; C22C 38/18; C22C 38/20; C21D 1/26; C22C 33/00; C23C 2/06

(52) U.S. Cl. CPC C22C 38/04; C22C 2202/00; C21D 8/0436; C22C 38/001; C22C 38/02; C22C 38/06; C22C 38/22; C23C 2/02; C21D 8/0226; C21D 8/0231; C22C 38/40; C21D 9/46; C22C 38/42; C21D 8/0431; C21D 6/005; C21D 8/0236; C22C 38/44; C22C 38/18; C22C 38/20; C21D 1/26; C22C 33/006; C22C 38/002; C23C 2/06; C21D 2211/001; C21D 2211/005; C21D 2211/008; C21D 2211/002; C21D 2211/004; C21D 2211/009; C21D 8/0426

(57) ABSTRACT

A high-strength, manganese-containing steel, in particular for producing a flexibly rolled flat steel product in the form of a hot or cold strip, includes the following chemical composition (in wt. %): C: 0.005 to 0.6; Mn: 4 to 10; Al: 0.005 to 4; Si: 0.005 to 2; P: 0.001 to 0.2; S: up to 0.05; N: 0.001 to 0.3; with the remainder being iron including unavoidable steel-associated elements, with optional alloying of one or more of the following elements (in wt. %): Sn: 0 to 0.5; Ni: 0 to 2; Cu: 0.005 to 3; Cr: 0.1 to 4; V: 0.005 to 0.9; Nb: 0.005 to 0.9; Ti: 0.005 to 0.9; Mo: 0.01 to 3; W: 0.1 to 3; Co: 0.1 to 3; B: 0.0001 to 0.05; Zr: 0.005 to 0.5; Ca: 0.0002 to 0.1 which has a good combination of strength, expansion and deformation properties.

### CROSS-REFERENCES TO RELATED APPLICATIONS

This application is a divisional of prior filed copending U.S. application Ser. No. 15/749,732, filed Feb. 1, 2018, the priority of which is hereby claimed under 35 U.S.C. § 120 and which is the U.S. National Stage of International Application No. PCT/EP2016/068575, filed Aug. 3, 2016, which designated the United States and has been published as International Publication No. WO 2017/021464 and which claims the priority of German Patent Application, Serial No. 10 2015 112 889.6, filed Aug. 5, 2015, pursuant to 35 U.S.C. 119(a)-(d).

### BACKGROUND OF THE INVENTION

The invention relates to a high-strength, manganese-containing TRIP and/or TWIP steel for producing a flexibly rolled flat steel product with an increased resistance to hydrogen-induced delayed crack formation (delayed fracture) and hydrogen embrittlement, to a use of this steel for producing a flexibly rolled flat steel product, to a method for producing a flat steel product from this steel and a flat steel product produced by this method.

European patent application EP 2 383 353 A2 discloses a high-strength, manganese-containing steel, a flat steel product formed from this steel and a method for producing this flat steel product. The steel consists of the elements (contents are in weight percent and relate to the steel melt): C: to 0.5; Mn: 4 to 12.0; Si: up to 1.0; Al: up to 3.0; Cr: 0.1 to 4.0; Cu: up to 4.0; Ni: up to 2.0; N: up to 0.05; P: up to 0.05; S: up to 0.01; with the remainder being iron and unavoidable impurities. Optionally, one or more elements from the group “V, Nb, Ti” are provided, wherein the sum of the contents of these elements is at most equal to 0.5. This steel is said to be characterised in that it can be produced in a more cost-effective manner than steels containing a high content of manganese and at the same time has high elongation at fracture values and, associated therewith, a considerably improved deformability. A method for producing a flat steel product from the high-strength, manganese-containing steel described above comprises the following working steps: —smelting the above-described steel melt, —producing a starting product for subsequent hot rolling, in that the steel melt is cast into a string from which at least one slab or thin slab is separated off as a starting product for the hot rolling, or into a cast strip which is supplied to the hot rolling process as a starting product, —heat-treating the starting product in order to bring the starting product to a hot rolling starting temperature of 1150 to 1000° C., —hot rolling the starting product to form a hot strip having a thickness of at most 2.5 mm, wherein the hot rolling is terminated at a hot rolling end temperature of 1050 to 800° C., —reeling the hot strip to form a coil at a reeling temperature of ≤700° C.

Furthermore, German patent document DE 10 2012 110 972 discloses a method for producing a product from flexibly rolled strip material. By means of flexibly rolling, a flexibly rolled strip material is produced from a strip material having a substantially constant thickness and has a thickness which can vary over the length of the strip material.

Furthermore, German laid-open document DE 10 2012 013 113 A1 already describes so-called TRIP steels which have a predominantly ferritic basic microstructure having incorporated residual austenite which can convert into martensite during deformation (TRIP effect). Owing to its strong cold solidification, the TRIP steel achieves high values for uniform elongation and tensile strength. TRIP steels are used inter alia in structural components, chassis components and crash-relevant components of vehicles, as sheet metal blanks, tailored blanks (welded blanks) and as flexibly cold-rolled strips, so-called TRBs. The flexibly cold-rolled strips allow a significant reduction in weight because the sheet metal thickness is adapted to the loading over the length of the component.

Proceeding therefrom, the object of the present invention is to provide a high-strength, manganese-containing TRIP and/or TWIP steel, in particular for producing a flexibly rolled hot strip or cold strip, having good deformation properties and an increased resistance to hydrogen-induced delayed crack formation and hydrogen embrittlement, a use of this steel for flexibly rolled flat steel products, a method for producing a flexibly rolled flat steel product from this steel, and a flat steel product produced by this method, which offer a good combination of strength and deformation properties in relation to the steel, and wherein the flat steel product has uniform properties even in the case of different degrees of deformation.

### SUMMARY OF THE INVENTION

This object is achieved by a high-strength, manganese-containing TRIP and/or TWIP steel, in particular for producing a flexibly rolled hot strip or cold strip with an increased resistance to hydrogen-Induced delayed crack formation and hydrogen embrittlement as set forth hereinafter, by a use of this steel for flexibly rolled flat steel products as set forth hereinafter, by a method for producing a flat steel product, in particular using the aforementioned steel as set forth hereinafter, and by a flat steel product produced by this method. Advantageous embodiments of the invention are described in the dependent claims.

In accordance with the invention, a high-strength, manganese-containing steel, in particular for producing a flexibly rolled flat steel product in the form of a hot or cold strip, having the following chemical composition (in wt. %): C: 0.005 to 0.6; Mn: 4 to 10; Al: 0.005 to 4; Si: 0.005 to 2; P: 0.001 to 0.2; S: up to 0.05; N: 0.001 to 0.3; with the remainder being iron including unavoidable steel-associated elements, with optional alloying of one or more of the following elements (in wt. %): Sn: 0 to 0.5; Ni: 0 to 2; Cu: 0.005 to 3; Cr: 0.1 to 4; V: 0.005 to 0.9; Nb: 0.005 to 0.9; Ti: 0.005 to 0.9; Mo: 0.01 to 3; W: 0.1 to 3; Co: 0.1 to 3; B: 0.0001 to 0.05; Zr: 0.005 to 0.5; Ca: 0.0002 to 0.1 offers a good combination of strength, expansion and deformation properties. Good weldability is also provided. Moreover, the production of this manganese steel in accordance with the invention having a medium manganese content (medium manganese steel) on the basis of the alloy elements C, Mn, Al and Si is relatively cost-effective. The manganese steel in accordance with the invention is also characterised by an increased resistance to delayed crack formation (delayed fracture) and to hydrogen embrittlement. The steel in accordance with the invention is an alloy which has a TRIP and/or TWIP effect which improves the deformability and tensile strength. Furthermore, component failure in the event of excess loads is hereby attenuated in that the component is locally deformed, wherein stresses are dissipated and as a result sudden failure, e.g. by the component breaking, is reduced. Moreover, the steel in accordance with the invention is particularly suitable for producing a flexibly rolled hot strip or cold strip. The flexibly roiled flat steel product has uniform properties even in the case of different degrees of deformation over the length of the strip by means of the alloy composition in accordance with the invention.

The alloy in accordance with the invention or the flexibly rolled flat steel product produced therefrom has a multi-phase microstructure, consisting of ferrite and/or martensite and/or bainite and residual austenite. The residual austenite content is 5% to 75%. The residual austenite is partially or completely converted into martensite by the TRIP effect upon applying correspondingly high mechanical stresses. Owing to the TRIP effect, the elongation at fracture, in particular uniform elongation, and the tensile strength increase considerably.

The use of the term “to” in the definition of the content ranges, such as e.g. 0.005 to 0.6 wt. %, means that the limit values—0.005 and 0.6 in the example—are also included.

Advantageously, the steel has a tensile strength Rm of at least 700 MPa, preferably >800 to 1600 MPa, and an elongation at fracture A50 of 6% to 45%. The expansion and toughness properties are advantageously improved by the onset of the TRIP and/or TWIP effect of the alloys in accordance with the invention.

Alloy elements are generally added to the steel in order to influence specific properties in a targeted manner. An alloy element can thereby influence different properties in different steels. The effect and interaction generally depend greatly upon the quantity, presence of further alloy elements and the solution state in the material. The correlations are varied and complex. The effect of the alloy elements in the steel in accordance with the invention will be discussed in greater detail hereinafter. The positive effects of the alloy elements used in accordance with the invention will be described hereinafter:

Carbon C: is required to form carbides, stabilises the austenite and increases the strength. Higher contents of C impair the welding properties and result in the impairment of the expansion and toughness properties in the steels in accordance with the invention, for which reason a maximum content of 0.6 wt. % is set. In order to achieve a sufficient strength for the material, a minimum addition of 0.005 wt. % is provided.

Manganese Mn: stabilises the austenite, increases the strength and the toughness and permits a deformation-induced martensite formation and/or twinning in the alloy in accordance with the invention. Contents of less than 4 wt. % are not sufficient to stabilise the austenite and thus impair the expansion properties whereas with contents of 10 wt. % and more the austenite is stabilised too much and as a result the strength properties, in particular the yield strength, are reduced. For the manganese steel in accordance with the invention having medium manganese contents, a range of 4 to 10 wt. % is preferred.

Aluminium Al: Al is used to deoxidise steels. Furthermore, an Al content of greater than 0.1 wt. % advantageously improves the strength and expansion properties and positively influences the conversion behaviour of the alloy in accordance with the invention. Furthermore, an improvement in the cold-rollability could be seen by alloying Al. At less than 4 wt. %, Al delays the precipitation of carbides. Higher Al contents also considerably impair the casting behaviour in the continuous casting process. This produces increased outlay when casting. Contents of Al of more than 4 wt. % impair the expansion properties. Therefore, a maximum content of 4 wt. % and a minimum content of >0.005 wt. % are set. Preferably, a minimum Al content of greater than 0.1 wt. % is set. In a particularly preferred manner, the minimum Al content is >0.5 wt. %, wherein the content of dissolved nitrogen in the alloy is limited to <300 ppm.

Silicon Si: impedes the diffusion of carbon, reduces the specific density and increases the strength and expansion properties and toughness properties. Furthermore, an improvement in the cold-rollability could be seen by alloying Si. Contents of more than 2 wt. % result, in the alloys in accordance with the invention, in embrittlement of the material and negatively influence the hot- and cold-rollability and the coatability e.g. by galvanising. Therefore, a maximum content of 2 wt. % and a minimum content of 0.005 wt. % are set. Preferably, a minimum Si content of greater than 0.5 wt. % is set.

Preferably, the sum of the contents (in wt. %) of Al and Si is fixed at >0.8.

Phosphorus P: is a trace element from the iron ore and is dissolved in the iron lattice as a substitution atom. Phosphorous increases the hardness and improves the hardenability by means of mixed crystal solidification. However, attempts are generally made to lower the phosphorous content as much as possible because inter alia it exhibits a strong tendency towards segregation owing to its low diffusion rate and greatly reduces the level of toughness. The attachment of phosphorous to the grain boundaries can cause cracks along the grain boundaries during hot rolling. Moreover, phosphorous increases the transition temperature from tough to brittle behaviour by up to 300° C. For the aforementioned reasons, the phosphorous content is limited to less than or equal to 0.2 wt. % and a minimum content of 0.001 wt. % is provided.

Sulphur S: like phosphorous, is bound as a trace element in the iron ore. It is generally not desirable in steel because it exhibits a strong tendency towards segregation and has a greatly embrittling effect. An attempt is therefore made to achieve amounts of sulphur in the melt which are as low as possible (e.g. by deep vacuum treatment). For the aforementioned reasons, the sulphur content is limited to less than or equal to 0.05 wt. %.

Nitrogen N: N is likewise an associated element from steel production. In the dissolved state, it improves the strength and toughness properties in steels containing a higher content of manganese of greater than or equal to 4 wt. % Mn. Lower Mn-alloyed steels of less than 4 wt. % with free nitrogen tend to have a strong ageing effect. The nitrogen even diffuses at low temperatures to dislocations and blocks same. It thus produces an increase in strength associated with a reduction in toughness properties. Binding of the nitrogen in the form of nitrides is possible by alloying e.g. aluminium, vanadium, niobium or titanium. For the aforementioned reasons, the nitrogen content is limited to less than 0.3 wt. % and a minimum content of 0.001 wt. % is provided.

Tin Sn: tin increases the strength but, similar to copper, accumulates beneath the scale layer and at the grain boundaries at higher temperatures. This results, owing to the penetration into the grain boundaries, in the formation of low-melting phases and, associated therewith, in cracks in the microstructure and in solder brittleness, for which reason a maximum content of less than or equal to 0.5 wt. % is optionally set. Preferably, a minimum content is 0.005 wt. %.

Nickel Ni: Ni stabilises the austenite and improves the expansion properties, in particular at low application temperatures, for which reason a maximum content of less than or equal to 2.0 wt. % is optionally set. Preferably, a minimum content is 0.1 wt. %.

Copper Cu: reduces the rate of corrosion and increases the strength. Contents of above 3 wt. % impair the producibility by forming low-melting phases during casting and hot rolling, for which reason a maximum content of 3 wt. % and a minimum content of 0.05 wt. % are optionally set. In a particularly preferred manner, a minimum content is set to 0.1 wt. %.

Chromium Cr improves the strength and reduces the rate of corrosion, delays the formation of ferrite and perlite and forms carbides. The maximum content is optionally set to less than 4 wt. % since higher contents result in an impairment of the expansion properties. A minimum Cr content is set to 0.1 wt. %.

Microalloy elements are generally added only in very small amounts (<0.1 wt. % per element). In contrast to the alloy elements, they mainly act by precipitation formation but can also influence the properties in the dissolved state. Despite the small amounts added, microalloy elements greatly influence the production conditions and the processing properties and final properties.

Typical microalloy elements are vanadium, niobium and titanium. These elements can be dissolved in the iron lattice and form carbides, nitrides and carbonitrides with carbon and nitrogen.

Vanadium V and niobium Nb: these act in a grain-refining manner in particular by forming carbides, whereby at the same time the strength, toughness and expansion properties are improved. Contents of in each case more than 0.9 wt. % do not provide any further advantages. Minimum contents of in each case 0.005 wt. % can optionally be added.

Titanium Ti: acts in a grain-refining manner as a carbide forming agent, whereby at the same time the strength, toughness and expansion properties are improved and the inter-crystalline corrosion is reduced. Contents of Ti of more than 0.9 wt. % impair the expansion and deformation properties in the alloys in accordance with the invention, for which reason a maximum content of 0.9 wt. % is optionally set. Minimum contents of 0.005 wt. % can optionally be added.

Molybdenum Mo: acts as a strong carbide forming agent and increases the strength. Contents of Mo of more than 3 wt. % impair the expansion properties, for which reason a maximum content of 3 wt. % and a minimum content of 0.01 wt. % are optionally set.

Tungsten W: tungsten acts as a carbide forming agent and increases the strength and heat resistance. Contents of W of more than 3 wt. % impair the expansion properties, for which reason a maximum content of 3 wt % and a minimum content of 0.1 wt. % are optionally set.

Cobalt Co: cobalt increases the strength of the steel, stabilises the austenite and improves the heat resistance. Contents of more than 3 wt. % impair the expansion properties in the alloys in accordance with the invention, for which reason a maximum content of 3 wt. % and a minimum content of 0.1 wt. % are optionally set.

Boron B: boron improves the strength and stabilises the austenite. Contents of more than 0.05 wt. % result in embrittlement of the material. Therefore, in the steel in accordance with the invention B is optionally alloyed in the range of 0.0001 wt. % to 0.05 wt. %. In a particularly preferred manner, a minimum content is set to 0.0005 wt. %.

Zirconium Zr: zirconium acts as a carbide forming agent and improves the strength. Contents of Zr of more than 0.5 wt. % impair the expansion properties, for which reason a maximum content of 0.5 wt. % and a minimum content of 0.005 wt. % are optionally set. In a particularly preferred manner, a minimum content is set to 0.01 wt %.

Calcium Ca: Calcium is used for modifying non-metallic oxidic inclusions which could otherwise result in the undesired failure of the alloy as a result of inclusions in the microstructure which act as stress concentration points and weaken the metal composite. Furthermore, Ca improves the homogeneity of the alloy in accordance with the invention. In order to achieve a corresponding effect, a minimum content of 0.0002 wt. % is necessary. Contents of above 0.1 wt. % Ca do not provide any further advantage in the modification of inclusions, impair producibility and should be avoided by reason of the high vapour pressure of Ca in steel melts.

The steel in accordance with the invention described above is particularly suitable for producing flexibly rolled flat steel products which allow a reduction in weight and thus lower production costs and an increase in efficiency owing to the adapted sheet metal thickness profile. Flexibly rolled flat steel products are used e.g. in the automotive industry (vehicle bodies), agricultural engineering, rail vehicle construction, traffic engineering or in household appliances.

In accordance with the invention, a method for producing a flat steel product, in particular from the steel described above, comprising the steps of: —smelting a steel melt containing (in wt. %): C: 0.005 to 0.6; Mn: 4 to 10; Al: 0.005 to 4; Si: 0.005 to 2; P: 0.001 to 0.2; S: up to 0.05; N: 0.001 to 0.3; with the remainder being iron including unavoidable steel-associated elements, with optional alloying of one or more of the following elements (in wt. %): Sn: 0 to 0.5; Ni: 0 to 2; Cu: 0.005 to 3; Cr: 0.1 to 4; V: 0.005 to 0.9; Nb: 0.005 to 0.9; Ti: 0.005 to 0.9; Mo: 0.01 to 3; W: 0.1 to 3; Co: 0.1 to 3; B: 0.0001 to 0.05; Zr: 0.005 to 0.5; Ca: 0.0002 to 0.1; —casting the steel melt to form a pre-strip by means of a horizontal or vertical strip casting process approximating the final dimensions or casting the steel melt to form a slab or thin slab by means of a horizontal or vertical slab or thin slab casting process, —flexibly hot rolling the pre-strip, in particular with a thickness of greater than 3 mm, or the slab or thin slab to form a flexibly rolled flat steel product, or hot rolling the pre-strip, in particular with a thickness of greater than 3 mm, or the slab or thin slab to form a hot strip with a unitary thickness, —optionally annealing the hot strip, —flexibly cold rolling the hot strip rolled to a unitary thickness or the cast pre-strip approximating the final dimensions having a thickness of less than or equal to 3 mm utilising the TRIP and/or TWIP effect to form a flexibly rolled flat steel product, or cold rolling the hot strip rolled to a unitary thickness or the cast pre-strip approximating the final dimensions having a thickness of less than or equal to 3 mm to form a cold strip having a unitary thickness, optionally annealing the cold strip and then flexibly cold rolling the cold strip rolled to a unitary thickness utilising the TRIP and/or TWIP effect to form a flexibly rolled flat steel product, —annealing the flexibly rolled flat steel product with the following parameters: annealing temperature: 600 to 750° C., annealing duration: 1 minute to 48 hours provides a flat steel product having a good combination of strength, expansion and deformation properties, and an increased resistance to delayed crack formation and hydrogen embrittlement and additionally has a TRIP and/or TWIP effect during mechanical loading.

In the context of the above method in accordance with the invention, a pre-strip produced with the two-roller casting process and approximating the final dimensions and having a thickness of less than or equal to 3 mm, preferably 1 mm to 3 mm is already understood to be a hot strip with a unitary thickness. The pre-strip thus produced as a hot strip with a unitary thickness does not have a 100% cast structure owing to the introduced deformation of the two rollers running in opposite directions. Hot rolling thus already takes place in-line during the two-roller casting process which means that separate hot rolling is not necessary.

The flexibly rolled flat steel product is annealed at an annealing temperature of 600 to 750° C. and an annealing duration of 1 minute to 48 hours. Higher temperatures are associated with shorter treatment times and vice versa. Annealing can take place both e.g. in a batch-type annealing process (longer annealing times) and e.g. in a continuous annealing process (shorter annealing times). By way of the annealing, approximately homogeneous mechanical properties can be set in the different thickness ranges of the flexibly rolled flat steel product, said properties ensuring good processability in the subsequent deformation process.

The method in accordance with the invention results as a whole, via optimisation of the metallurgy, hot rolling conditions and the temperature-time parameters in the annealing system, in a cold strip or hot strip which is particularly well suited for subsequent flexible rolling. A batch-type annealing system or a continuous annealing system are considered e.g. as the annealing system.

In relation to other advantages, reference is made to the above statements relating to the steel in accordance with the invention. The method results in a flexibly rolled flat steel product as a semi-finished product for subsequent deformation, which advantageously has a TRIP and/or TWIP effect. The alloy in accordance with the invention hereby demonstrates the particular behaviour that strengths and expansion characteristic values are set at the same level in the case of the different sheet metal thicknesses of the flexibly rolled flat steel product during the subsequent annealing over the entire strip length. These strengths and expansion characteristic values are virtually independent of the degree of cold deformation.

In conjunction with the present invention, “flexible rolling” is understood to mean a method for producing flat steel products in which a flat steel product having different thicknesses is produced in virtually any sequence in the rolling direction via an adjustable nip. The homogeneous transition between two constant thicknesses is advantageous. Differences in thickness of up to 50% can be achieved within a flexibly rolled flat steel product. The flat steel product produced via flexible rolling is preferably used in order to then be deformed, in terms of a pre-fabricated semi-finished product, e.g. by deep drawing or roll profiling to form a desired component. The deformed components are used in various ways in the automotive industry to produce vehicle bodies. The flexible rolling advantageously ensures that the flexibly rolled flat steel product has thickness profiles which are adapted, in terms of loading, to the component to be subsequently deformed therefrom, whereby a saving is accordingly made in material and weight and more components can be integrated with each other without additional joining processes, which leads to lower production costs. In particular, components which are subjected to different loading over their length are considered.

As shown in table 1, the non-cold-deformed strip and the cold-deformed strip have a similar strength and elongation at fracture after an identical heat treatment. This indicates that the properties can be set independently of the degree of cold deformation and thus ideal suitability for flexibly rolled flat steel products is provided.

Table 2 shows the chemical composition in wt. % of the examined alloys in accordance with the invention.

A flexibly rolled flat steel product produced by the method in accordance with the invention has a tensile strength Rm of at least 700 MPa, preferably of Rm >800 to 1600 MPa, and an elongation at fracture A50 of 6% to 45%.

Preferably, the flexibly rolled flat steel product is galvanised by hot-dipping or electrolytically or is coated metallically, inorganically or organically.

TABLE 1
laboratory results of a hot and cold strip under the
same annealing conditions

| | Annealing | Retention | | | | |
|---|---|---|---|---|---|---|
| | temperature | time | Rp0.2 | Rm | Ag | A50 |
| WB1 | 638° C. | 24 hours | 415 | 787 | 16.0 | 18.5 |
| KB1 | 638° C. | 24 hours | 359 | 812 | 13.1 | 15.1 |
| WB2 | 638° C. | 24 hours | 367 | 800 | 13.3 | 16.7 |
| KB2 | 638° C. | 24 hours | 419 | 751 | 14.3 | 16.2 |
| WB3 | 680° C. | 5 hours | 710 | 940 | 27.5 | 31.4 |
| KB3 | 680° C. | 5 hours | 740 | 980 | 25.6 | 31.2 |

WB: hot strip, ca. 2 mm
KB: cold strip, ca. 1 mm (ca. 50% cold deformation)
Rp0.2: 0.2% elasticity limit
Rm: tensile strength
Ag: uniform elongation
A50: elongation at fracture

TABLE 2
examined alloys in accordance with the invention

| | C | Mn | Al | Si | P |
|---|---|---|---|---|---|
| WB1/ | 0.2 | 5 | 0.025 | 0.008 | 0.001 |
| KB1 | | | | | |
| WB2/ | 0.2 | 5 | 0.025 | 0.008 | 0.001 |
| KB2 | | | | | |
| WB3/ | 0.2 | 7 | 1.9 | 0.5 | 0.001 |
| KB4 | | | | | |

| | S | N | Cr | B |
|---|---|---|---|---|
| WB1/ | 0.0012 | 0.001 | 0.001 | 0 |
| KB1 | | | | |
| WB2/ | 0.0012 | 0.001 | 0.001 | 0 |
| KB2 | | | | |
| WB3/ | 0.0014 | 0.001 | 0.974 | 0.0002 |
| KB4 | | | | |

### BRIEF DESCRIPTION OF THE DRAWING

NONE

### DETAILED DESCRIPTION OF PREFERRED EMBODIMENTS

NONE

What is claimed is:

1. A method for producing a flat steel product, comprising:
smelting a steel melt with a following composition in wt. %:
C: 0.005 to 0.6
Mn: 4 to 10
Al: 0.005 to 4
Si: 0.005 to 2
P: 0.001 to 0.2
S: up to 0.05
N: 0.001 to 0.3,
with the remainder being iron including unavoidable steel-associated elements;
casting the steel melt to form a pre-strip by a horizontal or vertical strip casting process approximating a final dimension or casting the steel melt to form a slab or thin slab by a horizontal or vertical slab or thin slab casting process;
flexibly hot rolling the pre-strip, or the slab or thin slab to form a flexibly rolled flat steel product;
annealing the flexibly rolled flat steel product at an annealing temperature of 600 to 750° C. and annealing duration of 1 minute to 48 hours;
wherein the residual austenite is partially or completely converted into martensite by a TRIP effect upon applying high mechanical stresses.

2. The method of claim 1, wherein the steel melt contains at least one alloying element in wt. % selected from the group consisting of:
Sn: 0 to 0.5
Ni: 0 to 2
Cu: 0.05 to 3
Cr: 0.1 to 4
V: 0.005 to 0.9
Nb: 0.005 to 0.9
Ti: 0.005 to 0.9
Mo: 0.01 to 3
W: 0.1 to 3
Co: 0.1 to 3
B: 0.0001 to 0.05
Zr: 0.005 to 0.5
Ca: 0.0002 to 0.1.

3. The method of claim 1, wherein the pre-strip has a thickness of greater than 3 mm.

4. A method for producing a flat steel product, comprising:
smelting a steel melt with a following composition in wt. %:
C: 0.005 to 0.6
Mn: 4 to 10
Al: 0.005 to 4
Si: 0.005 to 2
P: 0.001 to 0.2
S: up to 0.05
N: 0.001 to 0.3,
with the remainder being iron including unavoidable steel-associated elements;
casting the steel melt to form a pre-strip by a horizontal or vertical strip casting process approximating a final dimension or casting the steel melt to form a slab or thin slab by a horizontal or vertical slab or thin slab casting process;
hot rolling the pre-strip, or the slab or thin slab to form a hot strip with a unitary thickness;
optionally annealing the hot strip,
flexibly cold rolling the hot strip rolled to a unitary thickness or the cast prestrip approximating the final dimension having a thickness of less than or equal to 3 mm utilising the TRIP and/or TWIP effect to form a flexibly rolled flat steel product;
annealing the flexibly rolled flat steel product at an annealing temperature of 600 to 750° C. and annealing duration of 1 minute to 48 hours;
wherein the residual austenite is partially or completely converted into martensite by a TRIP effect upon applying high mechanical stresses.

5. The method of claim 4, wherein the steel melt contains at least one alloying element in wt. % selected from the group consisting of:
Sn: 0 to 0.5
Ni: 0 to 2
Cu: 0.05 to 3
Cr: 0.1 to 4
V: 0.005 to 0.9
Nb: 0.005 to 0.9
Ti: 0.005 to 0.9
Mo: 0.01 to 3
W: 0.1 to 3
Co: 0.1 to 3
B: 0.0001 to 0.05
Zr: 0.005 to 0.5
Ca: 0.0002 to 0.1.

6. The method of claim 5, wherein the pre-strip has a thickness of greater than 3 mm.

7. A method for producing a flat steel product, comprising:
smelting a steel melt with a following composition in wt. %:
C: 0.005 to 0.6
Mn: 4 to 10
Al: 0.005 to 4
Si: 0.005 to 2
P: 0.001 to 0.2
S: up to 0.05
N: 0.001 to 0.3,
with the remainder being iron including unavoidable steel-associated elements;
casting the steel melt to form a pre-strip by a horizontal or vertical strip casting process approximating a final dimension or casting the steel melt to form a slab or thin slab by a horizontal or vertical slab or thin slab casting process;
hot rolling the pre-strip, or the slab or thin slab to form a hot strip with a unitary thickness;
optionally annealing the hot strip,
cold rolling the hot strip rolled to a unitary thickness or the cast pre-strip approximating the final dimension having a thickness of less than or equal to 3 mm to form a cold strip having a unitary thickness, optionally annealing the cold strip and then flexibly cold rolling the cold strip rolled to a unitary thickness utilising the TRIP and/or TWIP effect to form a flexibly rolled flat steel product;
annealing the flexibly rolled flat steel product at an annealing temperature of 600 to 750° C. and annealing duration of 1 minute to 48 hours;
wherein the residual austenite is partially or completely converted into martensite by a TRIP effect upon applying high mechanical stresses.

8. The method of claim 7, wherein the steel melt contains at least one alloying element in wt. % selected from the group consisting of:
Sn: 0 to 0.5
Ni: 0 to 2
Cu: 0.05 to 3
Cr: 0.1 to 4
V: 0.005 to 0.9
Nb: 0.005 to 0.9
Ti: 0.005 to 0.9
Mo: 0.01 to 3
W: 0.1 to 3
Co: 0.1 to 3
B: 0.0001 to 0.05
Zr: 0.005 to 0.5
Ca: 0.0002 to 0.1.

9. The method of claim 7, wherein the pre-strip has a thickness of greater than 3 mm.
